(19) United States
(12) Patent Application Publication
(10) Pub. No.: US 2005/0058401 A1
(43) Pub. Date: Mar. 17, 2005

(54) Keyed adapter and connector

(76) Inventors: Charles Maynard, Watertown, CT (US); Frank Velleca, Woodbury, CT (US)

Correspondence Address: CANTOR COLBURN, LLP, 55 GRIFFIN ROAD SOUTH, BLOOMFIELD, CT, 06002, US

(21) Appl. No.: 10/884,218

(22) Filed: Jul. 2, 2004

Related U.S. Application Data
(60) Provisional application No. 60/485,614, filed on Jul. 7, 2003.

(51) Int. Cl. G02B 6/38; H01R 25/00

(52) U.S. Cl. 385/56; 439/677

(57) ABSTRACT

A connector and adapter arrangement that includes a connector housing having a main body with a plurality of sides and each of the plurality of sides has a corresponding slot extending in an axial direction. An adapter housing having an interior that includes a plurality of inner walls and each of the inner walls has a corresponding rib extending in the axial direction. The corresponding ribs are arranged centrally on the inside wall of the adapter housing and each of the slots is configured to mate with the ribs. Both the interior has an alteration and the main body has an alteration and the alterations are configured to mate.

### CROSS-REFERENCE TO RELATED APPLICATIONS

The present application claims the benefit of the date of the earlier filed provisional application, having U.S. Provisional Application No. 60/485,614, filed on Jul. 7, 2003, which is incorporated herein in its entirety.

### BACKGROUND OF THE INVENTION

The invention relates generally to adapters and in particular to a keyed adapter and connecter.

Optical fibers are used in an increasing number and variety of applications, such as a wide variety of telecommunications and data transmission applications. As a result, fiber optic networks must include an ever increasing number of enclosures in which one or more of the optical fibers are interconnected or otherwise terminated. Thus, with the increased number and variety of applications, it is important to ensure that the proper cable is connected to the proper adapter. In addition, when connecting the various fiber optic cables, it is important that the optical fibers being connected are properly aligned in both the axial and transverse directions so that there is minimal loss of light resulting from the connection.

### SUMMARY OF THE INVENTION

A connector and adapter arrangement that includes a connector housing having a main body with a plurality of sides and each of the plurality of sides has a corresponding slot extending in an axial direction. An adapter housing having an interior with a plurality of inner walls and each of the inner walls has a corresponding rib extending in the axial direction. The corresponding ribs are arranged centrally on each of the inside walls of the adapter housing and each of the slots is configured to mate with the ribs. The interior has an alteration and the main body has an alteration and the alterations are configured to mate.

A method of preventing a non-MT-RJ connector housing from mating with an MT-RJ adapter housing, the method includes forming a plurality of ribs along inside walls of the MT-RJ adapter housing and extending a length of at least one rib in an axial direction along at least one inside wall of the MT-RJ adapter housing, so as to form at least one elongated rib.

### BRIEF DESCRIPTION OF THE FIGURES

Referring now to the drawings wherein like elements are numbered alike in the several Figures:

FIG. 1 is a perspective view of a connector housing.

FIG. 2 is a perspective view of an adapter housing.

FIG. 3 is a perspective view of a connector housing in an alternate embodiment.

FIG. 4 is a perspective view of an adapter housing in the alternate embodiment.

### DETAILED DESCRIPTION

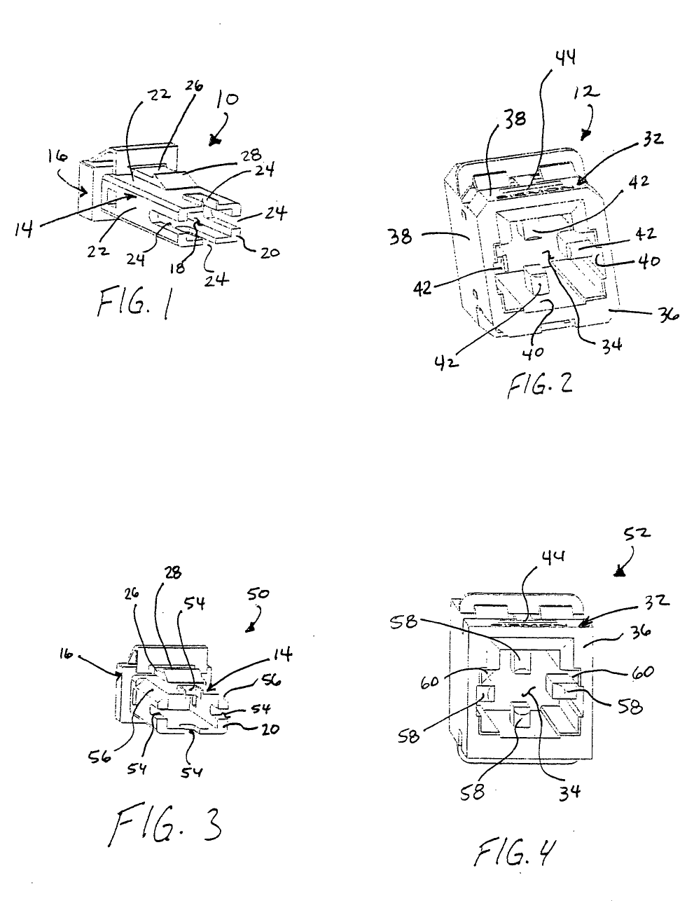

FIGS. 1-4 illustrate two embodiments of a connector housing 10 and 50 and an adapter housing 12 and 52. It is understood that both the connector housing 10 and 50 and the adapter housing 12 and 52 will be fitted with additional components to establish the fiber-to-fiber connection as is known in the art.

FIG. 1 is a perspective view of a connector housing 10. In an exemplary embodiment, connector housing 10 is a MT-RJ connector housing. The connector housing 10 has a main body 14 and a rear plate 16. Main body 14 includes an opening 18 at a front face 20. Opening 18 is surrounded by a plurality of sides 22, which in this embodiment is four. Each side 22 has a slot 24. One of the sides 22, which in this embodiment is the top side, includes an extension 26 with a nub 28.

In an exemplary embodiment, at least one of the slots 24 has an elongated length as compared to a standard slot size for a MT-RJ connector. The elongated length is accomplished by extending slot 24 towards rear plate 16. Additional slots 24 may extend closer to rear plate 16.

FIG. 2 is a perspective view of an adapter housing 12. In an exemplary embodiment, adapter housing 12 is a MT-RJ adapter housing. The adapter housing 12 has a main body 32 that includes an opening 34 at front face 36. Opening 34 is surrounded by a plurality of sides 38, which in this embodiment are four. Each side 38 has an inside wall 40 that has a rib 42, which is centrally located on each inside wall 40 and is aligned on two orthogonal axes as is found in standard MT-RJ adapters. Each rib 42 extends in an axial direction along inside wall 40 of main body 32. In addition, main body 32 has an opening 44 that receives nub 28 so as to secure connector 10 to adapter 12.

In an exemplary embodiment, at least one of the ribs 42 has an elongated length as compared a standard rib size for a MT-RJ adapter housing. The elongated rib 42 is accomplished by extending the rib 42 closer to front face 36. In addition, additional ribs 42 may extend closer to front face 36.

Referring to FIGS. 1 and 2, connector housing 10 mates with adapter housing 12. Front face 20 is inserted into opening 34 so that main body 14 slides in the axial direction within opening 34 of main body 32. Each slot 24 receives each rib 42 and the longer slot(s) 24 receives the longer rib(s) 42. By having at least one longer slot 24 and rib 42, there is no inadvertent mating of an inappropriate connector with the adapter housing.

In one embodiment, the keying is achieved by extending the alignment ribs 42 of adapter housing 12 by 0.100 inches individually to achieve four keying options. Alternatively, extending the alignment ribs 42 by 0.050 inches for multiple keys allows for additional keying options. The keying prevents inadvertent mating of non-compatible or standard connectors with adapter 12 that has at least one elongated rib 42. Elongated rib 42 will bottom out in a non-elongated slot of a standard MT-RJ connector or a non MT-RJ connector, thereby preventing mating of the connector housing with the adapter housing. Connector 10 with an elongated slot 24 will be able to properly mate with adapter 12.

Moreover, by varying which slot 24 and rib 42 are elongated and also varying the number of slots 24 and ribs 42 that are elongated and the amount they are elongated, there are a number of different embodiments for connector 10 and adapter 12, which increases the number of options as to restricting the connectors that can mate with the adapters. There can be increased security in that only the persons with the proper connector can connect to the specific adapter. A person that does not have the correct connector would not be able to connect to the adapter. In particular, the elongated rib would prevent a connector that does not have the elongated slot from mating with the adapter. Thus, connector housing 10 and adapter housing 12 accomplishes both unauthorized access and inadvertent mating.

The connector housing 10 and the adapter housing 12 may be color coded to identify which keyed connector mates with which keyed adapter. Alternatively, color-coded icons may be used to identify mating connectors/adapters.

FIG. 3 is a perspective view of a connector housing 50 in an alternate embodiment. FIG. 4 is a perspective view of an adapter housing 52 in the alternate embodiment. In an exemplary embodiment, connector housing 50 and adapter housing 52 are a MT-RJ connector housing and a MT-RJ adapter housing, respectively. The connector housing 50 is similar to connector housing 10, except that instead of having slot(s) 24 be elongated, connector housing 50 has all slots 54 of a same size. In addition, at least one side and/or corner 56 (hereinafter referred to as side 56, in which side 56 means side and/or corner) has been altered, such as chamfered or beveled. The altered side(s) 56 extends from the front face 20 along the axial length of main body 14 of connector housing 50. Multiple variations can also occur with the altered side 56 in that individual sides may be altered or a plurality of sides may be altered. The size of the alteration may also create additional variations. FIG. 3 illustrates two sides 56 being altered.

Adapter housing 52 is similar to adapter housing 12, except that instead of having rib(s) 42 be elongated, adapter housing 42 has all ribs 58 of a same size. The adapter housing 52 has a front face 36 having a generally rectangular opening 34. One or more sides and/or corners 60 (hereinafter referred to as side 60, in which side 60 means side and/or corner) of opening 34 are chamfered. The altered side(s) 60 extends from front face 36 along the axial length of opening 34 within main body 32 of adapter housing 52. Side 60 correspond to the side 56 on connector housing 50. By altering one or more sides 56 and sides 60, the connector housing 50 and adapter housing 52 are keyed to prevent inadvertent mating. The keying is accomplished by the altered sides and/or corners 56 and 60. In addition, the altered sides and/or corners 56 and 60 may also be combined with the embodiment shown in FIGS. 1 and 2 (elongated ribs and slots) to create addition variations for the keyed connectors and adapters.

As with connector housing 10 and adapter housing 12, connector housing 50 and adapter housing 52 may also be color coded to identify which keyed connector mates with which keyed adapter. Alternatively, color-coded icons may be used to identify mating connectors/adapters.

A benefit of the embodiments shown in FIGS. 1-4 is that the ribs 42 and 58 are aligned on orthogonal axes, equally positioned around a central ferrule (not shown) to provide optimal alignment. Existing keyed MT-RJ connectors and adapters shift the lateral position of the ribs and slots thereby compromising alignment. By having the ribs centralized on each inside wall, the alignment of the optical fibers is optimized. Thus, the optical fibers being connected are properly aligned in both the axial and transverse directions so that there is minimal loss of light resulting from the connection. In addition, the connector and adapter are keyed with minimal disruption to the alignment advantages of the connector/adapter design.

While this invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention.

1. A connector and adapter arrangement comprising:
a connector housing having a plurality of slots extending in an axial direction, at least one slot is an elongated slot; and
an adapter housing having a plurality of ribs extending in said axial direction, at least one rib is an elongated rib,
wherein each of said of plurality of slots is configured to mate with said plurality of ribs, said elongated slot mates with said elongated rib.

2. The arrangement of claim 1, wherein said elongated rib has a length that extends closer to a front face of said adapter housing than said other ribs.

3. The arrangement of claim 1, wherein said elongated slot has a length that extends closer to a back side of said adapter housing than said other slots.

4. The arrangement of claim 1, wherein said connector housing and said adapter housing are a same color.

5. The arrangement of claim 1, wherein said connector housing has a main body with at least one side that is altered, said adapter housing has at least one inside wall that is altered, said altered side of said connector housing is configured to mate with said altered inside wall of said adapter housing.

6. The arrangement of claim 1, wherein said connector housing is an MT-RJ connector housing and said adapter housing is an MT-RJ adapter housing.

7. The arrangement of claim 1, wherein when said connector housing is mated with said adapter housing, said connector has an extension that is received in an opening that disposed at said adapter housing.

8. A connector and adapter arrangement for an optical fiber comprising:
a connector housing having a main body with a plurality of sides and at least one of said plurality of sides is altered; and
an adapter housing having a plurality of inner walls and at least one of said plurality of inner walls is altered,
wherein said altered side is configured to mate with said altered inner wall.

9. The arrangement of claim 8, wherein said connector housing is an MT-RJ connector housing and said adapter housing is an MT-RJ adapter housing.

10. The arrangement of claim 8, wherein when said connector housing is mated with said adapter housing, said connector has an extension that is received in an opening that disposed at said adapter housing.

11. A connector and adapter arrangement comprising:
a connector housing having a main body with a plurality of sides, each of said plurality of sides having a corresponding slot extending in an axial direction, said main body having an alteration;
an adapter housing having an interior, said interior including a plurality of inner walls, each of said inner walls having a corresponding rib extending in said axial direction, said corresponding ribs arranged centrally on said inside wall of said adapter housing, each of said slots is configured to mate with said ribs, said interior having an alteration; and
wherein said alteration of said interior is configured to mate with said alteration of said main body.

12. The arrangement of claim 11, wherein said alteration of said interior is an elongated rib and said alteration of said main body is an elongated slot.

13. The arrangement of claim 11, wherein said alteration of said interior is an altered inner wall and said alteration of said main body is an altered main body side.

14. The arrangement of claim 11, wherein said connector housing is an MT-RJ connector housing and said adapter housing is an MT-RJ adapter housing.

15. A method of preventing a non-MT-RJ connector housing from mating with an MT-RJ adapter housing, the method comprising:
forming a plurality of ribs along inside walls of said MT-RJ adapter housing;
extending a length of at least one rib in an axial direction along at least one inside wall of said MT-RJ adapter housing, so as to form at least one elongated rib.

16. The method of claim 15, wherein said extending includes extending said length closer to a front face of said adapter housing.
